(19) United States
(12) Patent Application Publication
(10) Pub. No.: US 2010/0011020 A1
(43) Pub. Date: Jan. 14, 2010

(54) RECOMMENDER SYSTEM

(75) Inventors: Makram Bouzid, Palaiseau (FR); David Bonnefoy, Paris (FR); Nicolas Lhuillier, Versailles (FR); Kevin C. Mercer, Wantage (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/171,327

(22) Filed: Jul. 11, 2008

(51) Int. Cl. G06F 17/30

(52) U.S. Cl. 707/103 R; 707/E17.046

(57) ABSTRACT

A method for providing individualized recommendations to a user on a multi-user device is provided. During operation anonymous user preferences of similar program content will be grouped to form clusters of similar preferences. Context information for each cluster is determined and the clusters are grouped to form larger clusters. The grouping is based on the context information for each cluster. A current context is then determined and at least one larger cluster is found that has a similar context as the current context. The larger cluster is used to make a recommendation for the user.

### FIELD OF THE INVENTION

The invention relates to recommendation of content items and in particular, but not exclusively, to recommendation of television or radio programs.

### BACKGROUND OF THE INVENTION

In recent years, the availability and provision of multimedia and entertainment content has increased substantially. For example, the number of available television and radio channels has grown considerably and the popularity of the Internet has provided new content distribution means. Consequently, users are increasingly provided with a plethora of different types of content from different sources. In order to identify and select the desired content, the user must typically process large amounts of information which can be very cumbersome and impractical.

Accordingly, significant resources have been invested in research into techniques and algorithms that may provide an improved user experience and assist a user in identifying and selecting content. For example, Digital Video Recorders (DVRs) or Personal Video Recorders (PVRs) have become increasingly popular and are increasingly replacing conventional Video Cassette Recorders (VCRs) as the preferred choice for recording television broadcasts. Such DVRs (in the following the term DVR is used to denote both DVRs and PVRs) are typically based on storing the recorded television programs in a digital format on a hard disk or optical disc. Furthermore, DVRs can be used both for analogue television transmissions (in which case a conversion to a digital format is performed as part of the recording process) as well as for digital television transmissions (in which case the digital television data can be stored directly).

Increasingly, devices, such as televisions or DVRs provide new and enhanced functions and features which provide an improved user experience. For example, televisions or DVRs can comprise functionality for providing recommendations of television programs to the user. More specifically, such devices can comprise functionality for monitoring the viewing/recording preferences of a user. These preferences can be stored in a user preference profile and subsequently can be used to autonomously select and recommend suitable television programs for viewing or recording. For example, a DVR may automatically record programs which are then recommended to the user, for example by inclusion of the automatically recorded programs in a listing of all the programs recorded by the DVR.

Such functionality may substantially improve the user experience. Indeed, with hundreds of broadcast channels diffusing thousands of television programs per day, the user may quickly become overwhelmed by the offering and therefore may not fully benefit from the availability of content. Furthermore, the task of identifying and selecting suitable content becomes increasingly difficult and time-consuming. The ability of devices to provide recommendations of television programs of potential interest to the user substantially facilitates this process.

In order to enhance the user experience, it is advantageous to personalize the recommendations to the individual user. In this context, the process of generating recommendations requires that user preferences have been captured so that they can be used as input by the prediction algorithm.

There are two main techniques used to collect user preferences. The first approach is to explicitly obtain user preferences by the user(s) manually inputting their preferences, for example by manually providing feedback on content items that the user(s) particularly liked or disliked. The other approach is to implicitly obtain user preferences by the system monitoring user actions to infer their preferences.

Most of the known recommendation approaches are not ideal in the context of television viewing. A television or video recorder, such as specifically a DVR, is commonly a multi-user device and the activity of watching television is characterized by being a low effort and highly passive activity. In this context, although users ask for individual recommendations, asking users to authenticate to the system and/or creating individual user profiles tends not to be easy or effective.

Therefore, a need exists for an improved system for content item recommendation that allowed for improved suitability for multi-user environments.

### BRIEF DESCRIPTION OF THE DRAWINGS

FIG. 1 is a block diagram of a device for making content item recommendations.

FIG. 2 illustrates a user preference comprising a context and a content part.

FIG. 3 illustrates time and location signatures for various clusters.

FIG. 4 shows context signatures for various clusters of similar programs.

FIG. 5 illustrates the regrouping of clusters.

FIG. 6 is a flow chart showing operation of the device of FIG. 1.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION OF THE DRAWINGS

In order to alleviate the above-mentioned need, a method for providing recommendations to a user on a multi-user device is provided. During operation preferences of similar program content will be grouped to form clusters of similar preferences. Context information for each cluster is determined based on cluster content and the clusters are grouped to form larger clusters. The grouping is based on the similarity of context information between clusters. A current context is then determined and at least one larger cluster is found that has a similar context as the current context. The larger cluster is used to make a program recommendation for the user.

Since users of a device typically utilize the device during a particular context (e.g., a particular time, device, location, . . . , etc.), the current technique has a high probability of recommending to users, the programming that they wish to watch.

The present invention encompasses a method for providing individualized recommendations to a user on a multi-user device. The method comprises the steps of grouping preferences of similar program content to form clusters of similar preferences, determining context information for each cluster, and grouping clusters to form larger clusters. A current context is then determined and at least one larger cluster is chosen that has a similar context as the current context. The larger cluster is used to make a recommendation for the current context.

The present invention additionally encompasses an apparatus comprising a storage storing user preferences and a processor accessing the storage. The processor groups preferences of similar program content to form clusters of similar preferences. The processor determines context information for each cluster and groups clusters to form larger clusters based on a similarity of context information of each cluster. The processor additionally accesses a context generator to determine a current context and chooses at least one larger cluster that has a similar context as the current context to make a recommendation.

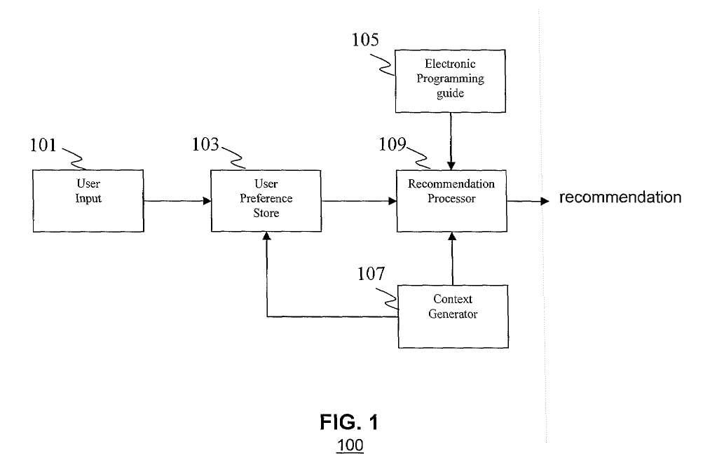

Turning now to the drawings, where like numerals designate like components, FIG. 1 is a block diagram of a device for making content item recommendations. The device may for example be a DVR or a television. The device of FIG. 1 comprises functionality for recommending content items to a user. For example, the device may recommend upcoming television programs to the user of the device. The device uses an approach for generating recommendations which is based on anonymous user ratings which are received from a plurality of unidentified users. The device can then target the recommendations to a user based on contextual information pertaining to the user's use of the device.

The device comprises a user input 101, user preference store 103, electronic programming guide (EPG) 105, context generator 107, and recommendation processor 109. Electronic Program Guide (EPG) 105 indicates the television programs that will be transmitted in, say, the next week. In addition to the time and titles of the television programs, EPG 105 can contain further meta-data such as an indication of the genre, actors, directors etc. As another example, EPG 105 may alternatively or additionally be provided with information of television programs that has been recorded by e.g. a DVR.

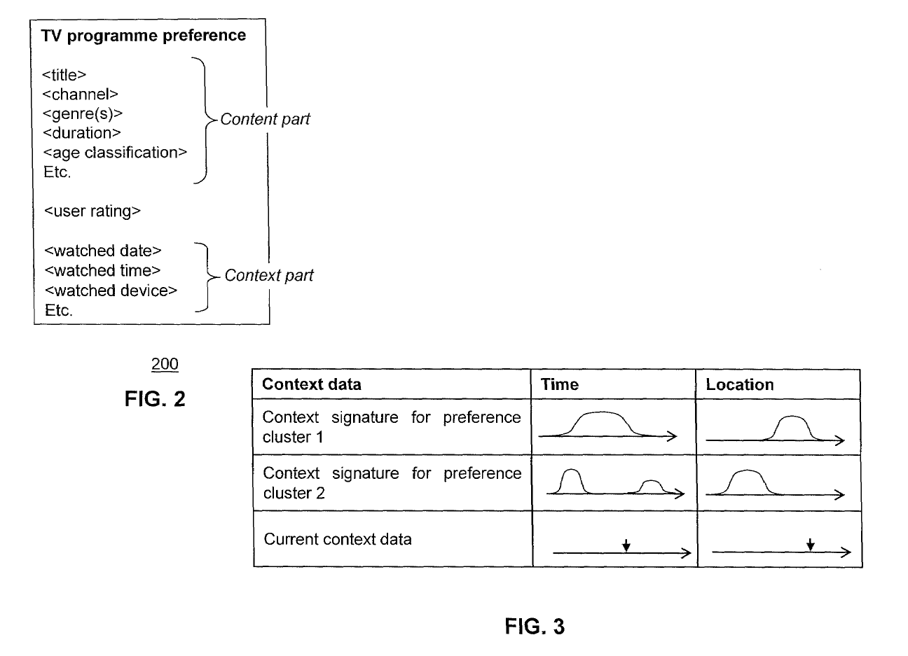

User input 101 can receive manual inputs from one or more users of the device. User input 101 can receive anonymous feedback of user preferences for various content items. As an example, a user watching or playing back a specific television program can manually input a rating of the program. User input 101 may also accumulate “implicit preference inputs” (e.g. system silently monitoring the users). User input 101 is coupled to a user preference store 103. When a user preference about a program is received from the user input 101, a user rating record comprising the user preference measure and content item data describing the contents is stored in the user preference store 103. Contextual information about the program is also stored in storage 103. This information is received from context generator 107. Such contextual information may, for example, be a time when the program was watched, or a device that was utilized to watch the program. Thus, a user preference can be seen as comprising two parts: a first part describing the content this preference relates to and the associated user preference value and a second part describing the context (e.g. time, location, etc.) when this preference was explicitly expressed by the user or implicitly inferred from their behaviour. This is illustrated in FIG. 2 where user preference 200 comprises a context part and a content part.

Device 100 is a multi-user device that may be used by many different users. Furthermore, the user preferences are inputted without any identification of the specific user that is providing the data. Accordingly, the user preference records stored in the user preference store 103 are anonymous user preferences and the records do not comprise any information of the identity of the user who provided the input. Hence, it is not feasible to generate content item recommendations which are personalized to an individual user based only on the stored user preferences. Rather, such an approach provides recommendations which can be customized for the whole group of users using the device.

Recommendation processor 109 utilizes preference store 103 and context generator 107 in order to recommend a particular program to a user of device 100. Recommendation processor 109 utilizes the following steps to make recommendations:
1. Group user preferences according to similarities between their content description. A clustering algorithm could be used, such as K-means, and a function computing the similarity of two programs P₁, P₂ for instance as the weighted sum of the similarity of their descriptive metadata P_{i,1}, Pᵢ₂, . . . (e.g. genre, channel, etc.):

$$similarity ( {P}_{1} , {P}_{2} ) = {\int }_{i ∈ \{ metadata ( P ) \}} {α}_{i} \cdot {similarity}_{i} ( {P}_{i , 1} , {P}_{i , 2} )$$

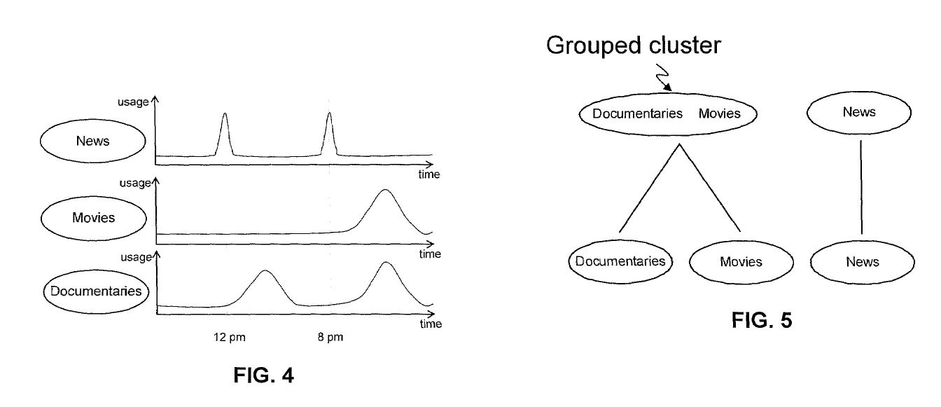

After step 1, multiple clusters of user preferences are created. A k-means clustering algorithm initially defines k clusters with given initial parameters. The user rating records are then matched to the k clusters. The parameters for each cluster are then recalculated based on the user rating records that have been assigned to each cluster. The algorithm then proceeds to reallocate the user rating records to the k clusters in response to the updated parameters for the clusters. If these operations are iterated a sufficient number of times, the clustering converges resulting in k groups of content items having similar properties. The idea behind this step is that similar preferences grouped in one cluster should correspond to the preferences of a particular user or group of users sharing the same tastes.
2. Extract/compute context information for each preference cluster (referred to as a context signature). The idea behind this step is that a cluster of similar preferences may correspond to one or more different contexts of use (e.g. a user likes watching game shows at the end of the morning and at the end of the afternoon).
3. Build larger clusters by grouping clusters having similar average contexts. Since a group of preferences may correspond to different contexts of use and family members have generally particular and fixed TV viewing patterns, i.e. each member or family subgroup have their particular contexts of TV use (e.g. children watch TV in the afternoon and parents in the evening), grouping clusters according to context similarity should more likely represent the preferences of that same user or group of users even if the current content is not similar (e.g. FIG. 4 and 5).
4. When making recommendations, the current context is used to identify which clusters have the closest context signature (generated in steps 1 and 2). These can then be expanded to select the list of groups to utilize, following the bottom-up hierarchical links (a threshold may be used to stop the expansion). A personalization algorithm from those available in the state-of-the-art, e.g. a Naïve Bayes classifier, can be used to determine the list of recommendations, using only as training set the preferences from the selected groups. This is illustrated in FIG. 3.

In FIG. 3, time information and location information is shown for two clusters. Also, a current time and location is shown. As is evident, the time and location information for cluster 1 is a better match than for cluster 2. This fact will be taken into consideration when a recommendation is made.

5. A subset from the list of recommendations computed at the previous step is then selected by the system and presented to the user. The retained list includes elements recommended using the basic groups of preferences which contexts matched directly the current context, and also elements recommended using the groups identified by the expansion (as defined in previous step). The size of this subset can be fixed by the system (e.g. according to available space on the GUI) and/or by the user.

A simple example will now be provided to show how the system works in practice. For the sake of simplicity, we will consider two users and only time as context information. Users' habits are the following:
User 1 watches the news at noon and early evening;
User 2 watches movies at night;
User 2 watches documentaries in the afternoon or at night.
   Recommendation processor 109 will create three clusters for three program types, with the associated context signatures shown in FIG. 4 (for the sake of simplicity, the clustering is made using a similarity measure involving TV program genres only). Processor 109 then regroups (hierarchical clustering) as shown in FIG. 5, based on similarity of their context signatures. Note that in our example the hierarchy is partial: the ‘News’ cluster remains on its own, as there is no other cluster with a similar enough context signature.

Thus, for example, in the early afternoon, the best matching cluster is the ‘Documentaries’ one. But if this cluster does not provide recommendations, or not enough (e.g. if there is no documentary in the afternoon that day), the system can go up the hierarchy and use the combined ‘Documentaries’ and ‘Movies’ cluster, then recommending a movie based on the preferences part of the ‘Movies’ cluster.

In the above example, device 100 was able to recommend programs that the user likes, even if he is not used to watch this type of programs at this particular time of the day. Thus, device 100 can make the best targeted recommendations (taking into account both preferences and context) when possible, but also able to make sensible recommendations when the available programs are less favourable.

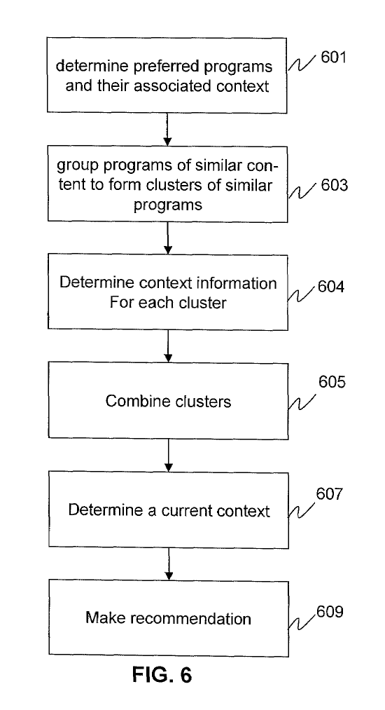

FIG. 6 is a flow chart showing operation of the device of FIG. 1 after preferred programs have been determined and stored in storage 103. In other words, FIG. 6 is a flow chart showing operation of the device of FIG. 1 after collecting anonymous implicit or explicit user preferences. These anonymous user ratings (which are received from a plurality of unidentified users) may be expressed as program ratings, comprising a content part and a context part.

The logic flow begins at step 601 where recommendation processor 109 accesses storage 103 to determine preferred programs and their associated context. In this example, the associated context will comprise a time the program was viewed, however, in alternate embodiments of the present invention, context information may comprise such things as what device the program was viewed on, a location where the program was viewed, . . . , etc.

At step 603 recommendation processor 109 accesses storage 103 to get user preferences, and groups preferences of similar program content to form clusters of similar preferences. A clustering algorithm may be used to form clusters. As discussed above, a clustering algorithm could be used for this task.

Context information is then determined for each cluster by processor 109 (step 604). The context information comprises when each cluster's content was viewed, where each cluster's content was viewed, or on what device each cluster's content was viewed.

Clusters can be combined (or grouped) by processor 109 to form larger clusters, wherein the grouping is based on the context information for each cluster (step 605). More specifically, clusters having very similar context data may be combined to form larger clusters. The step of grouping clusters to form larger clusters may comprise forming larger clusters from clusters whose content was viewed at a similar time, forming larger clusters from clusters whose content was viewed at a similar location, or forming larger clusters from clusters whose content was viewed on a similar device.

Recommendation processor 109 accesses context generator 107, determines a current context (step 607), and uses the larger clusters to make a recommendation at a given context (step 609). In this particular embodiment, recommendation processor 109 will determine a current context and choose a cluster that has a context that best matches the current context (choosing at least one larger cluster that has a similar context as the current context). The larger cluster will be used to make a recommendation for the current context. For example, processor 109 will choose a cluster that has a time watched that best matches the current time. Electronic programming guide 105 will be accessed and processor 109 will chose programming having a content similar to a content of a larger cluster. These programs will then be presented to the user.

While the invention has been particularly shown and described with reference to a particular embodiment, it will be understood by those skilled in the art that various changes in form and details may be made therein without departing from the spirit and scope of the invention. It is intended that such changes come within the scope of the following claims:

1. A method for providing individualized recommendations to a user on a multi-user device, the method comprising the steps of:
grouping preferences of similar program content to form clusters of similar preferences;
determining context information for each cluster;
grouping clusters to form larger clusters, wherein the grouping is based on a similarity of context information of each cluster;
determining a current context;
choosing at least one larger cluster that has a similar context as the current context; and
using a larger cluster to make a recommendation for the current context.

2. The method of claim 1 wherein the context information comprises when each cluster's content was viewed, where each cluster's content was viewed, or on what device each cluster's content was viewed.

3. The method of claim 1 wherein the step of grouping clusters to form larger clusters comprises forming larger clusters from clusters whose content was viewed at a similar time.

4. The method of claim 1 wherein the step of grouping clusters to form larger clusters comprises forming larger clusters from clusters whose content was viewed at a similar location.

5. The method of claim 1 wherein the step of grouping clusters to form larger clusters comprises forming larger clusters from clusters whose content was viewed on a similar device.

6. The method of claim 1 wherein the step of grouping preferences to form clusters comprises the step of using a clustering algorithm to form clusters.

7. The method of claim 1 wherein the step of using the larger cluster to make the recommendation comprises the steps of:
accessing an electronic programming guide;
choosing programming having a content similar to a content of the larger cluster; and
recommending a program that has the content similar to the content of the larger cluster.

8. The method of claim 1 wherein the recommendation comprises a TV program recommendation.

9. The method of claim 1 further comprising the step of:
collecting anonymous implicit or explicit user preferences, expressed as program ratings, comprising of a content part and a context part.

10. An apparatus comprising:
storage storing user preferences; and
a processor accessing the storage and grouping preferences of similar program content to form clusters of similar preferences, determining context information for each cluster and grouping clusters to form larger clusters, wherein the grouping is based on a similarity of context information of each cluster, the processor additionally accessing a context generator to determine a current context and choosing at least one larger cluster that has a similar context as the current context to make a recommendation.

11. The apparatus of claim 10 wherein the context information comprises when each cluster's content was viewed, where each cluster's content was viewed, or on what device each cluster's content was viewed.

12. The apparatus of claim 10 wherein the larger clusters are formed from clusters whose content was viewed at a similar time.

13. The apparatus of claim 10 wherein the larger clusters are formed from clusters whose content was viewed at a similar location.

14. The apparatus of claim 10 wherein the larger clusters are formed from clusters whose content was viewed on a similar device.

15. The apparatus of claim 10 wherein a clustering algorithm is used to form clusters.

16. The apparatus of claim 10 wherein the recommendation comprises a TV program recommendation.
